(19) United States
(12) Patent Application Publication
(10) Pub. No.: US 2025/0273073 A1
(43) Pub. Date: Aug. 28, 2025

(54) TAKING INTO ACCOUNT UNCERTAIN TIMING EFFECTS IN DISTRIBUTED CONTROL SYSTEMS

(71) Applicant: Robert Bosch GmbH, Stuttgart (DE)

(72) Inventors: Antoine Vandamme, Gerlingen (DE); Kevin Schmidt, Herrenberg (DE)

(21) Appl. No.: 19/054,033

(22) Filed: Feb. 14, 2025

(30) Foreign Application Priority Data
Feb. 22, 2024 (EP) 24 15 8993.6

(51) Int. Cl. G08G 1/00; B60W 50/00

(52) U.S. Cl. CPC G08G 1/22; B60W 50/0097; B60W 2050/0017

(57) ABSTRACT

A computer-implemented method for evaluating uncertain timing effects when controlling distributed systems with respect to one or more control variables. The method includes calculating a next time step in a simulation of an intrusive surrogate model for a mean value of a dynamic model, a mean value of an output of the dynamic model being calculated, wherein the dynamic model is designed to calculate the one or more control variables as the output; and calculating the next time step in a simulation of an intrusive surrogate model for a deviation, including a variance, of the dynamic model from the mean value of the dynamic model, wherein a deviation, in particular the variance, of the output of the dynamic model is calculated; wherein the control of the distributed systems depends on at least a first uncertain timing effect, which is represented in the dynamic model by a first uncertain parameter.

### BACKGROUND INFORMATION

The longitudinal vehicle guidance of a plurality of vehicles is an example of a distributed control system, i.e., a system with distributed control functions. A special longitudinal vehicle guidance system is, for example, platooning, in which a plurality of vehicles drive one behind the other at a very short distance with the help of a distributed control system-also known as electronic tow bar(s)—without compromising road safety.

Distributed control systems are currently simulated deterministically. In reality, however, there are some physical effects that are stochastic (i.e., uncertain) and have a non-negligible influence on the distributed control system. This particularly concerns uncertain timing effects. In this respect, deterministic simulations of distributed control systems are inadequate.

An example of an uncertain timing effect is jitter, which can be described as a slight fluctuation in the accuracy of the transmission clock. In the case of platooning, for example, jitter can be a time-dependent dispersion of the sampling time of a computing unit of the distributed control system that manages the dynamics of one or more vehicles.

Another example of an uncertain timing effect is dead time, which can be used to describe a delay with which a change at the input becomes noticeable in a reaction at the output of a controlled system. In the case of platooning, the dead time can, for example, comprise communication time between computing units of two vehicles.

Within the framework of product virtualization, it is desirable and necessary to take such stochastic effects into account in the early design phase. As a result, platooning, for example, can be designed to be robust at an early stage.

Methods and systems to take into account uncertain timing effects in the simulation of distributed control systems, in particular to represent, for example, time-variant jitter effects and, among other things, dead times in platooning stochastically with an efficient uncertainty quantification method (e.g., based on the intrusive chaos polynomial method-hereinafter abbreviated to IPC) are not known.

The present invention addresses the problem of taking into account uncertain timing effects in the simulation of distributed control systems. In particular, time-variant jitter effects and, among other things, dead times in platooning are to be represented stochastically using an efficient uncertainty quantification (UQ) method.

### SUMMARY

A first general aspect of the present invention relates to a computer-implemented method for evaluating uncertain timing effects when controlling distributed systems with respect to one or more control variables. According to an example embodiment of the present invention, the method comprises calculating a next time step in a simulation of an intrusive surrogate model for a mean value of a dynamic model, wherein a mean value of an output of the dynamic model is calculated. The dynamic model is designed to calculate one or more control variables as (the) output. The method further comprises calculating the next time step in a simulation of an intrusive surrogate model for a deviation, in particular for a variance, of the dynamic model from the mean value of the dynamic model, wherein a deviation, in particular the variance, of the output of the dynamic model is calculated. The control of distributed systems depends on at least a first uncertain timing effect, which is represented in the dynamic model by a first uncertain parameter.

The control of distributed systems may depend on a second uncertain timing effect, which is represented in the dynamic model by a second uncertain parameter. The control of distributed systems may depend on other uncertain timing effects.

A second general aspect of the present invention relates to a computer system designed to carry out the computer-implemented method for evaluating uncertain timing effects when controlling distributed systems with respect to one or more control variables according to the first general aspect of the present invention (or an embodiment thereof).

A third general aspect of the present invention relates to a computer program designed to carry out the computer-implemented method for evaluating uncertain timing effects when controlling distributed systems with respect to one or more control variables according to the first general aspect of the present invention (or an embodiment thereof).

A fourth general aspect of the present invention relates to a computer-readable medium or signal that stores and/or contains the computer program according to the third general aspect of the present invention (or an embodiment thereof).

The method according to the first general aspect of the present invention (or an embodiment thereof) makes it possible to take into account one or more uncertain timing effects in the simulation of a distributed control system in an efficient UQ method (e.g., in an IPC method). This makes possible efficient UQ analyses that can be used at design time and/or runtime. As a result, the controllers involved in a distributed control system can be designed robustly and adapted at any time if necessary.

In particular, thanks to the method according to the first general aspect of the present invention (or an embodiment thereof), uncertain jitter effects in combination with uncertain dead times in a distributed system can also be taken into account at an early stage during platooning.

Especially in the case of jitter effects, a very complex definition of an uncertain sampling time parameter per simulated time step (conventionally determined, e.g., by rolling dice à la Monte Carlo) can be dispensed with. However, longitudinal vehicle guidance (such as platooning) is only one example of a distributed control system. The platooning model can initially be formulated in a time-discrete manner and the jitter effect can be represented as uncorrelated white noise. The jitter effect can then be treated mathematically in the same way as a disturbance w(t) represented as uncorrelated white noise in a continuous-time state-space representation model.

The increased knowledge proves to be advantageous when applying the method proposed here: In the exemplary case of platooning, at each time step, both the mean value and the standard deviation (previously only a scalar value) can be calculated for each model output quantity (for example, relative speed and/or distance error between two vehicles) based on the entire possible range of jitter values (previously only a scalar value randomly drawn from a stochastic distribution, either at each time step or once at the beginning of the simulation) and/or the entire possible range of dead-time values (previously only a scalar value randomly drawn from a stochastic distribution, either at each time step or once at the beginning of the simulation).

Time savings also proves to be advantageous when applying the method proposed here: In contrast to conventional UQ methods (standard Monte Carlo, Latin hypercube sampling), the UQ tasks using the IPC method can be completed with just one simulation. It is not necessary, as in conventional approaches, to carry out (deterministic) simulations for each randomly drawn parameter of the timing effects.

The solution of the present invention can be used, for example, in platooning design and makes it possible for vehicle trajectories and/or system variances to be taken into account in an efficient manner during function development (safe-by-design approach).

The efficient representation of timing effects also makes it possible to take them into account in the control process. For example, stochastic “classic” controller designs and their application in model predictive control are possible.

The system description can contain additional dynamics, which also makes it possible to take into account correlated stochastic processes in the simulation of the distributed control system.

### BRIEF DESCRIPTION OF THE DRAWINGS

FIG. 1 schematically illustrates exemplary embodiments of a computer-implemented method for evaluating uncertain timing effects when controlling distributed systems with respect to one or more control variables, according to the present invention.

FIG. 2A illustrates exemplary control processes for a minimum distance error for two controllers with different control settings, according to an example embodiment of the present invention.

FIG. 2B illustrates exemplary speed differences between the distributed systems per control process from FIG. 2A.

FIG. 3 schematically illustrates the control of distributed systems using the example of at least longitudinal vehicle guidance, in particular platooning, according to an example embodiment of the present invention.

### DETAILED DESCRIPTION OF EXAMPLE EMBODIMENTS

The method 100 proposed in this disclosure is directed to evaluating uncertain timing effects (more precisely one or more timing effects) when controlling distributed systems with respect to one or more control variables.

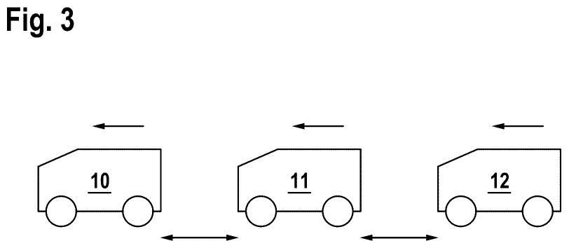

Such a control of distributed systems is illustrated by way of example and schematically in FIG. 3, wherein the at least two distributed systems 10, 11, 12 can be vehicles moving in a common direction (to the left in FIG. 3) and maintaining a small and as constant as possible distance from one another. Here, the vehicles are guided at least in one longitudinal direction (e.g., axis of the current driving direction or tangent of the trajectory to be driven). In such at least longitudinal vehicle guidance, the vehicles can form a convoy (via an electronic tow bar between two neighboring vehicles), which is also called platooning.

However, the method 100 proposed here can be directed to any control of distributed systems that depends on at least one uncertain timing effect, in particular at least on one static and/or one time-variant timing effect. In addition to at least longitudinal vehicle guidance, in particular platooning, there are many other relevant situations in which an interplay of uncertain timing effects is important:

For example, the control of distributed systems can be designed to operate and/or coordinate automated guided vehicles (AGVs) within a limited region, in particular such as a logistics center and/or a production facility, by means of a local network (e.g., local edge, 5G network, 6G network, etc.).

As another example, the distributed systems can comprise robotic arms in a local network, e.g., in a manufacturing system. The closed-loop control and/or open-loop control algorithms of at least these robot arms are at least partially outsourced (i.e., at least partially decentralized).

As a further example, the control of the distributed systems can involve lateral and/or longitudinal guidance of vehicles at traffic junctions and/or other control zones that are outsourced to a local edge and/or cloud system (e.g., a so-called roadside unit).

The distributed systems can, for example, also be controlled in classic E/E architectures with a plurality of control units in a vehicle.

The control of distributed systems 10, 11, 12 depends on at least one timing effect. In the context of this disclosure, timing effects are particularly relevant, and these are not the same every time. Thus, such timing effects can fluctuate. They are referred to here as uncertain timing effects.

Uncertain timing effects can, for example, be time-variant, i.e., they can fluctuate in continuous time even for a particular group of distributed systems to be controlled. An example of this is jitter, i.e., a fluctuation in the accuracy of the transmission clock of computing units in distributed systems.

Uncertain timing effects, on the other hand, can be static, i.e., they can be constant in continuous time for a certain group of distributed systems to be controlled, but can fluctuate across different groups of distributed systems to be controlled. An example of this is a time delay between computing units in distributed systems.

In platooning—e.g., in the form of connected adaptive cruise control, ACC or a joint group start—the control of the distributed systems may depend, for example, on a time delay (static) and jitter (time-variant, e.g., uncorrelated noise). The focus here is on the longitudinal guidance of the vehicles, which exchange information with one another. However, the exchange of information is subject to an unknown communication delay. The dynamics are described by the distance error e=d_{ref}−d and the relative speed Δν between two vehicles. The longitudinal acceleration can serve as the input signal here. Here, d is a distance between two adjacent vehicles and d_{ref} is a minimum distance that should ideally not be exceeded.

Thanks to the application of efficient uncertainty quantification analysis (UQ analysis) proposed here, controllers can be compared and/or optimized in terms of their performance on the stochastic system: This can be used for improved control setting—be it offline, i.e., subsequently, or online, i.e., already at distributed system control runtime—and/or for selecting the most suitable controller from a selection of existing controllers (e.g., K1 or K2). Furthermore, model predictive controllers, for example, can use the UQ analysis at runtime in order to iteratively determine optimal acceleration signals at runtime that can be applied to the relevant vehicle. As a result, a smaller minimum distance d_{ref} between vehicles can be reliably adjusted, allowing for energy savings, for example, due to better utilization of slipstream effects.

In a UQ analysis, the quality of the control of the distributed systems with different controllers K1 or K2 available for selection can be evaluated with an initial distance error e(0). For example, it is of interest to know at an early stage the probability of a potentially safety-critical situation occurring with a distance d<d_{ref} (or e>0) that is too small for a closed system.

Conventionally, the comparison of two controllers K1 and K2 with respect to uncertain static and/or time-variant timing effects required a large number of simulations for each of the two controllers (one controller based on controller K1, the other controller based on controller K1), since conventional UQ methods are not input-independent. Therefore, assessing whether a particular controller meets the (safety) requirements or the decision as to which controller is to be preferred can in particular not be made during operation. In addition, the input- dependent UQ methods are highly complex.

Thanks to the method 100 proposed in this disclosure, statistics can be ascertained with one simulation per controller, which increases efficiency and in particular makes use during runtime possible.

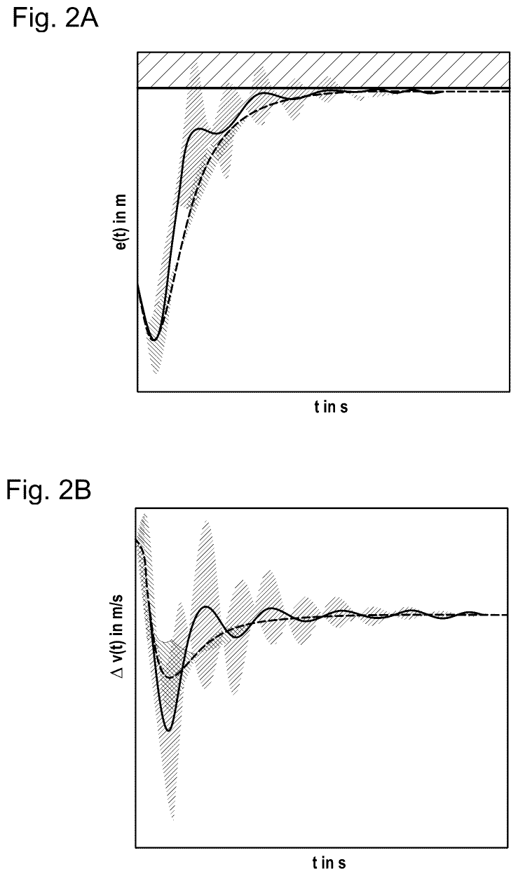

In FIG. 2A-2B, exemplary mean values of the outputs of the two controllers K1 and K2 are shown. Here, the solid line is the temporal progression of the mean value for the controller K1; the dashed line is the temporal progression of the mean value for the controller K2. In FIG. 2A, the temporal progression of the distance error e between two adjacent vehicles is shown; in FIG. 2B, the temporal progression of the relative speed of vehicles corresponding to this is shown. Exemplary 6σ confidence intervals (3ρ on either side of the mean value) are the hatched region around each of the mean values. The hatched region with lines from bottom left to top right is the temporal progression of the 6σ confidence interval for the controller K1; the hatched region with lines from top left to bottom right is the temporal progression of the 6σ confidence interval for the controller K2. It can be seen directly that controller K1 adjusts the minimum distance d_{ref} faster than controller K2, but introduces many oscillations compared to the alternative. Moreover, the response of the closed control loop with the controller K1, in contrast to the controller K2, exhibits significant portions with distance errors e>0 (i.e., less than the minimum distance d_{ref}). This poses a potential safety risk, in particular in long convoys. In this example, a controller K2 is therefore preferred.

A computer-implemented method 100 is now disclosed for evaluating uncertain timing effects (at least one uncertain timing effect) when controlling distributed systems 10, 11, 12 with respect to one or more control variables. The distributed systems form a distributed control system.

Evaluating (e.g., checking 160, see below) can initially be performed in a simulation and taken into account in the subsequent control of the distributed systems. Here, for example, a control setting can be adjusted 170 and/or selected 171. Alternatively, evaluating (e.g., checking 160) can be performed in a simulation that is carried out in parallel and in particular simultaneously with the control of the distributed systems. Such an evaluation can then even be taken into account online when controlling the distributed systems, e.g., by adjusting 170, see below, a control setting.

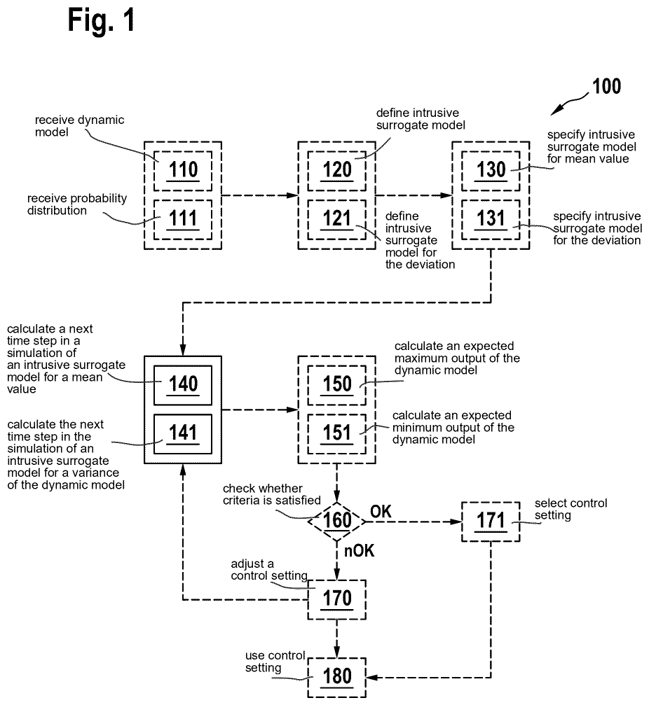

The method 100, illustrated by way of example and schematically in FIG. 1, comprises calculating 140 a next time step in a simulation of an intrusive surrogate model for a mean value of a dynamic model, wherein a mean value of an output of the dynamic model is calculated. The next time step is based on a time discretization of the dynamic model. Calculating 140 can be based on the intrusive polynomial chaos expansion (PCE) method.

The method 100 further comprises, as illustrated in FIG. 1, calculating 141 the next time step in an intrusive surrogate model simulation for a deviation of the dynamic model from the mean value of the dynamic model, wherein a deviation of the output of the dynamic model is calculated. The deviation can be a variance of the output of the dynamic model. In particular, the method 100 can comprise calculating 141 the next time step in the simulation of an intrusive surrogate model for a variance of the dynamic model from the mean value of the dynamic model, wherein a variance of the output of the dynamic model is calculated. Calculating 141 can also be based on the intrusive polynomial chaos expansion (PCE) method.

Calculating 140, 141 comprises in particular calculating mean values and deviations from the mean value for the output of the dynamic model. In the exemplary platooning, e.g., mean values and deviations from the mean value for the distance error and the relative speeds can be ascertained. Such distance errors are shown by way of example in FIG. 2A for two different controllers. The corresponding relative speeds are shown by way of example in FIG. 2B for two different controllers.

The dynamic model is designed to calculate one or more control variables as the output. In the exemplary platooning, one or more control variables can be, e.g., the distance error e and/or the relative speed Δσ between two vehicles.

The dynamic model can be time-discrete. An exemplary time-discrete dynamic model, in particular for platooning, can be:

$${z}_{k + 1} = f ( {z}_{k} , {u}_{k} , h + {h}_{k} , r )$$

Here, the integers k≥0 correspond to the discrete points in time. f is a specified function that represents the dynamics of distributed systems, in particular vehicles. zₖ is a state vector at point in time k, where z₀ is an initial state vector. Furthermore, uₖ is an optional input vector also at a point in time k, where u₀ is an initial input vector. The input vector uₖ can be omitted, for example, if the dynamic model f already represents the closed control loop (including control law). The dynamic model in this example has two additional arguments (the third and fourth in the formula for zₖ₊₁), via which the dynamic model may depend on two uncertain parameters. In this example, h can represent a nominal sampling time (e.g., a constant), and hₖcan represent a time-variant (i.e., time-dependent) uncertain jitter effect at point in time k. Furthermore, r can represent an uncertain dead time, which is, e.g., time-invariant (i.e., time-independent). In another example, f may depend on only one uncertain parameter (e.g., hₖ or r). In yet another example, f may depend on a plurality of uncertain parameters.

The method 100 can comprise, as illustrated, e.g., as an option in FIG. 1, receiving 110 the dynamic model.

The control of distributed systems may depend on at least a first uncertain timing effect, which is represented in the dynamic model by a first uncertain parameter. In the exemplary time-discrete dynamic model, the first uncertain timing effect can be an uncertain jitter effect and can, for example, be represented (i.e., parameterized) by the first uncertain parameter hₖ. The first uncertain parameter, in particular for the uncertain jitter effect, can be defined by a probability distribution. For example, hₖ can be defined as uncorrelated white noise with a mean value of μₕ and a standard deviation of sₕ, or equivalently, a variance of Σₕ=Σₕ².

The control of distributed systems may depend on a second uncertain timing effect, which is represented in the dynamic model by a second uncertain parameter. In the exemplary time-discrete dynamic model, the second uncertain timing effect can be an uncertain dead time and can, for example, be represented (i.e., parameterized) by the second uncertain parameter r. The second uncertain parameter, in particular for the uncertain dead time, can also be defined by a probability distribution. For example, r can be defined as a uniform distribution with a lower bound rₘᵢₙ and an upper bound rₘₐₓ.

In particular, the control of distributed systems may depend on at least two uncertain timing effects, which are represented in the dynamic model by at least two uncertain parameters.

If necessary, correlated uncertain timing effects can also be represented in the dynamic model. Correlated uncertain timing effects can be represented, for example, by additional dynamics and/or multivariate parameters. As a result, correlated stochastic processes can also be taken into account.

The method 100 can comprise, as illustrated, e.g., as an option in FIG. 1, receiving 111 a probability distribution for at least the first uncertain parameter, optionally also a probability distribution for the second uncertain parameter or probability distributions for each uncertain parameter of the plurality of uncertain parameters.

For example, the first uncertain timing effect can be time-variant. The first uncertain timing effect can in particular be a jitter effect, in particular a time-variant dispersion of the sampling time of a computing unit in one of the distributed systems.

For example, the second uncertain timing effect can be static. The second uncertain timing effect can in particular be a dead time in the communication between two or more systems of the distributed systems.

The method 100 can comprise, as illustrated, e.g., as an option in FIG. 1, defining 120 the intrusive surrogate model for the mean value (more generally, the expected value) of the dynamic model, in particular defining the mean value model. For this purpose, the first uncertain parameter of the dynamic model (for each time step) can be constrained to a mean value (e.g., μₕ for the white noise, more generally the expected value) of the first uncertain parameter. In the exemplary time-discrete dynamic model f, the mean values mₖ of the dynamic model can be defined in each time step k as follows:

$${m}_{k + 1} = f ( {m}_{k} , {u}_{k} , h + {μ}_{h} , r ) k > 0 , {m}_{0} = {z}_{0}$$

The method 100 can further comprise, as illustrated, e.g., as an option in FIG. 1, defining 121 the intrusive surrogate model for the deviation (in particular, the variance) of the dynamic model from the mean value of the dynamic model, in particular defining the variance model. For this purpose, starting from V₀=0, a variance Vₖ₊₁ of the dynamic model can be defined in each time step k based on the variance (e.g., Σₕ for the white noise) of the first uncertain parameter as follows:

$${V}_{k + 1} = \frac{\partial f}{\partial {z}_{k}} {\vert}_{{z}_{k} = {m}_{k} , {h}_{k} = {μ}_{h}}$$

$${V}_{k} \frac{\partial f}{\partial {z}_{k}} {\vert}_{{z}_{k} = {m}_{k} , {h}_{k} = {μ}_{h}}^{T} + \frac{\partial f}{\partial h} {\vert}_{{z}_{k} = {m}_{k} , {h}_{k} = {μ}_{h}}$$

$${\sum }_{h} \frac{\partial f}{\partial h} {\vert}_{{z}_{k} = {m}_{k} , {h}_{k} = {μ}_{h}}^{T}$$

The superscript T here denotes transposition.

In the event that the exemplary time-discrete dynamic model f does not have a fourth argument (i.e., no dependence on r), the fourth argument can also be omitted in the formulas for mₖ₊₁ and Vₖ₊₁.

In the case of a second uncertain timing effect or parameter, the method 100 can comprise, as illustrated, e.g., as an option in FIG. 1, specifying 130 the intrusive surrogate model for the mean value of the dynamic model, in particular specifying the mean value model. For this purpose, in the formulas for mₖ₊₁, r can be replaced by a polynomial in ξ that depends on an expected value of the probability distribution for the second uncertain parameter and, for example, a variance of this probability distribution. In the case of the equal distribution described above by way of example,

$$r = ( {r}_{max} + {r}_{min} ) / 2 + ( {r}_{max} - {r}_{min} ) / 2 * ξ$$

can be used.

The method 100 can comprise, as illustrated, e.g., as an option in FIG. 1, specifying 131 the intrusive surrogate model for the deviation (in particular, the variance) of the dynamic model from the mean value of the dynamic model, in particular specifying the variance model.

The polynomials in ξ required for the intrusive polynomial chaos expansion method can be defined in such a way that the mean values mₖ of the intrusive mean value model and, for example, the variances Vₖ₊₁ of the intrusive variance model are given by their coefficients.

In the intrusive PCE method, the statistical distribution of each uncertain parameter is approximated as a stochastic polynomial (a so-called “chaos polynomial”). The selection of polynomials is fixed and depends on the distribution assumption of the parameters. With this definition, all other model variables (for example, the model states, inputs and outputs) can also be represented and calculated as stochastic variables. However, this requires that the mathematical system equations be extended to include stochastic effects and discretized accordingly. The approach using the intrusive PCE method leads to a coupled system of system equations, which requires the adaptation of existing simulation environments.

The method 100 can comprise, as illustrated, e.g., as an option in FIG. 1, calculating 150, for the next time step, an expected maximum output (in a probabilistic sense, e.g., +3σ) of the dynamic model based on the mean value of an output of the dynamic model and the deviation, in particular the variance of the dynamic model from the mean value of the dynamic model.

Alternatively or additionally, as illustrated, e.g., as an option in FIG. 1, the method 100 can comprise calculating 151, for the next time step, an expected minimum output (in a probabilistic sense, e.g., −3σ) of the dynamic model based on the mean value of an output of the dynamic model and the deviation, in particular the variance of the dynamic model from the mean value of the dynamic model.

When calculating 150, 151, the deviation can be a standard deviation σ or a multiple of the standard deviation. The standard deviation can be ascertained from the square root of the variance.

In particular, as illustrated, e.g., as an option in FIG. 1, the method 100 can comprise calculating 150, for the next time step, an expected maximum output (in a probabilistic sense, e.g. +3σ) of the dynamic model based on the mean value of an output of the dynamic model and the deviation, in particular the variance of the dynamic model from the mean value of the dynamic model, and calculating 151, for the next time step, an expected minimum output (in a probabilistic sense, e.g., −3σ) of the dynamic model based on the mean value of an output of the dynamic model and the deviation, in particular the variance of the dynamic model from the mean value of the dynamic model.

The method 100 can comprise, as illustrated, e.g., as an option in FIG. 1, checking 160, at least for the next time step, whether the expected maximum output of the dynamic model and/or the expected minimum output of the dynamic model satisfy a predetermined criterion, wherein a check result is obtained. The check result can, for example, be positive (OK) or negative (nOK).

The method 100 can comprise, as illustrated, e.g., as an option in FIG. 1, adjusting 170 a control setting when controlling the distributed systems 10 based on the check result. Due to the adjustment 170, the controller can be optimized.

Alternatively or additionally, the method 100 can comprise, as illustrated, e.g., as an option in FIG. 1, selecting 171 the control setting from a plurality of control settings based on the check result. Each control setting can be assigned to a controller. A plurality of controllers (such as K1 or K2 above) can thus be examined here. The method 100 can be carried out for each of these controllers or control settings. In this way, a check result can be ascertained for each of these controllers or control settings. On the basis of these check results, one control setting, and thus one controller, can be selected 171. As a result, the best controller can be selected in particular.

The method 100 can comprise, as illustrated, e.g., as an option in FIG. 1, using 180 the control setting when controlling the distributed systems 10, 11, 12. Thus, for example, a software for controlling the distributed systems can be programmed with the control settings ascertained from the simulation and executed to control the distributed systems. As illustrated, e.g., in FIG. 1, the selected 171 control setting can be used 180 for controlling the distributed systems.

Alternatively or additionally, the method 100 can already be executed during the control of the distributed systems 10, 11, 12. Here, the simulation can thus run parallel to the control of the distributed systems. The advantage here is that the control setting can be adjusted during the control of the distributed systems, e.g., because the expected maximum distance error e has become too large, the minimum distance d_{ref} could be critically undercut. This makes possible a stochastic model predictive control of distributed systems at runtime.

The method 100 can further comprise a sensitivity analysis with respect to at least two uncertain timing effects. This sensitivity analysis can, for example, be based on a determination of Sobol indices of the intrusive surrogate models of the individual uncertain timing effects.

The control of the distributed systems can be designed for longitudinal, lateral and/or vertical motion control, in particular for the platooning of vehicles.

In particular, the control of the distributed systems can be designed at least for longitudinal motion control, e.g., for the platooning of vehicles.

Alternatively or additionally, the control of the distributed systems can be designed at least for lateral motion control.

Alternatively or additionally, the control of the distributed systems can be designed at least for vertical motion control.

In particular, the control of the distributed systems can be designed for longitudinal and lateral motion control.

In particular, the control of the distributed systems can be designed for longitudinal, lateral and vertical motion control.

The one or more control variables can comprise one or more distances between the distributed systems, in particular between the vehicles. Alternatively or additionally, the one or more control variables can comprise one or more relative speeds between the distributed systems.

Furthermore, a computer system is disclosed which is designed to perform the computer-implemented method 100 for evaluating uncertain timing effects when controlling distributed systems 10, 11, 12 with respect to one or more control variables. The computer system can comprise a processor and/or a working memory.

Furthermore, a computer program is disclosed which is designed to perform the computer-implemented method 100 for evaluating uncertain timing effects when controlling distributed systems 10, 11, 12 with respect to one or more control variables. The computer program can be present, for example, in interpretable or in compiled form. For execution, it can (even in parts) be loaded into the RAM of a computer, for example as a bit or byte sequence.

Also disclosed is a computer-readable medium or signal that stores and/or contains the computer program. The medium can comprise, for example, any one of RAM, ROM, EPROM, HDD, SSD, . . . , on/in which the signal is stored.

15. (canceled)

16. A computer-implemented method for evaluating uncertain timing effects when controlling a distributed system with respect to one or more control variables, the method comprising the following steps:
calculating a next time step in a simulation of an intrusive surrogate model for a mean value of a dynamic model, wherein a mean value of an output of the dynamic model is calculated, wherein the dynamic model is configured to calculate the one or more control variables as an output;
calculating the next time step in a simulation of an intrusive surrogate model for a deviation, including a variance, of the dynamic model from the mean value of the dynamic model, wherein the deviation, including the variance, of the output of the dynamic model is calculated;
wherein the control of the distributed systems depends on at least a first uncertain timing effect, which is represented in the dynamic model by a first uncertain parameter.

17. The method according to claim 16, wherein the control of the distributed systems depends on a second uncertain timing effect, which is represented in the dynamic model by a second uncertain parameter.

18. The method according to claim 16, comprising:
calculating, for the next time step, an expected maximum output of the dynamic model based on the mean value of an output of the dynamic model and the deviation, including the variance of the dynamic model from the mean value of the dynamic model; and/or
calculating, for the next time step, an expected minimum output of the dynamic model based on the mean value of an output of the dynamic model and the deviation, including the variance of the dynamic model from the mean value of the dynamic model.

19. The method according to claim 16, further comprising:
checking, at least for the next time step, whether the expected maximum output of the dynamic model and/or the expected minimum output of the dynamic model satisfy a predetermined criterion, wherein a check result is obtained.

20. The method according to claim 19, further comprising:
adjusting a control setting when controlling the distributed systems based on the check result; and/or
selecting the control setting from a plurality of control settings based on the check result.

21. The method according to claim 20, comprising:
using the control setting when controlling the distributed systems, wherein the method is executed during the control of the distributed systems.

22. The method according to claim 16, wherein the first uncertain timing effect is time-variant.

23. The method according to claim 22, wherein the first uncertain timing effect is a jitter effect, including a time-variant dispersion of a sampling time of a computing unit in one of the distributed systems.

24. The method according to claim 17, wherein the second uncertain timing effect is static.

25. The method according to claim 17, wherein the second uncertain timing effect is a dead time in a communication between two or more systems of the distributed system.

26. The method according to claim 16, wherein the control of the distributed systems is configured at least for longitudinal, and/or lateral and/or vertical motion control, for platooning of vehicles.

27. The method according to claim 26, wherein the one or more control variables include one or more distances between the vehicles.

28. A computer system configured to evaluate uncertain timing effects when controlling a distributed system with respect to one or more control variables, the computer system configured to:
calculate a next time step in a simulation of an intrusive surrogate model for a mean value of a dynamic model, wherein a mean value of an output of the dynamic model is calculated, wherein the dynamic model is configured to calculate the one or more control variables as an output;
calculate the next time step in a simulation of an intrusive surrogate model for a deviation, including a variance, of the dynamic model from the mean value of the dynamic model, wherein the deviation, including the variance, of the output of the dynamic model is calculated;
wherein the control of the distributed systems depends on at least a first uncertain timing effect, which is represented in the dynamic model by a first uncertain parameter.

29. A non-transitory computer-readable medium on which is stored a computer program for evaluating uncertain timing effects when controlling a distributed system with respect to one or more control variables, the computer program, when executed by a computer, causing the computer to perform the following steps:
calculating a next time step in a simulation of an intrusive surrogate model for a mean value of a dynamic model, wherein a mean value of an output of the dynamic model is calculated, wherein the dynamic model is configured to calculate the one or more control variables as an output;
calculating the next time step in a simulation of an intrusive surrogate model for a deviation, including a variance, of the dynamic model from the mean value of the dynamic model, wherein the deviation, including the variance, of the output of the dynamic model is calculated;
wherein the control of the distributed systems depends on at least a first uncertain timing effect, which is represented in the dynamic model by a first uncertain parameter.
